(19) United States
(12) Patent Application Publication
(10) Pub. No.: US 2025/0110623 A1
(43) Pub. Date: Apr. 3, 2025

(54) TECHNIQUES FOR CONTROLLING A DEVICE

(71) Applicant: Apple Inc., Cupertino, CA (US)

(72) Inventors: Arian BEHZADI, San Francisco, CA (US); Christopher P. FOSS, San Francisco, CA (US); Andrew S. KIM, Walnut Creek, CA (US); David A. KRIMSLEY, Sunnyvale, CA (US); Christopher D. MATTHEWS, San Francisco, CA (US); Corey K. WANG, Palo Alto, CA (US)

(21) Appl. No.: 18/896,660

(22) Filed: Sep. 25, 2024

Related U.S. Application Data
(60) Provisional application No. 63/541,820, filed on Sep. 30, 2023.
(60) Provisional application No. 63/541,806, filed on Sep. 30, 2023.
(60) Provisional application No. 63/541,815, filed on Sep. 30, 2023.

(51) Int. Cl. G06F 3/04842; G06F 3/0362

(52) U.S. Cl. CPC G06F 3/04842; G06F 3/0362

(57) ABSTRACT

The present disclosure generally relates to user interfaces and techniques for displaying controls that are used to control one or more operations of a device, such as configuring an input mechanism and/or displaying a user interface for controlling the navigation of a computer system.

### CROSS-REFERENCE TO RELATED APPLICATIONS

This application claims priority to U.S. Provisional Patent Application Ser. No. 63/541,820 entitled “TECHNIQUES FOR CONTROLLING A DEVICE,” filed Sep. 30, 2023, to U.S. Provisional Patent Application Ser. No. 63/541,815 entitled “TECHNIQUES FOR DISPLAYING DIFFERENT CONTROLS,” filed Sep. 30, 2023, and to U.S. Provisional Patent Application Ser. No. 63/541,806 entitled “USER INTERFACES FOR PERFORMING OPERATIONS,” filed Sep. 30, 2023, which are incorporated by reference herein in their entireties for all purposes.

### FIELD

The present disclosure relates generally to computer user interfaces, and more specifically to techniques for displaying controls that are used to control one or more operations a device.

### BACKGROUND

Electronic devices often display various types of controls. Such controls are used to control various operations of the electronic device.

### SUMMARY

Some techniques for displaying controls that are used to control one or more operations of a device using electronic devices, however, are generally cumbersome and inefficient. For example, some existing techniques use complex and time-consuming user interfaces, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for displaying controls that are used to control one or more operations of a device. Such methods and interfaces optionally complement or replace other methods for displaying controls that are used to control one or more operations of a device. Such methods and interfaces reduce the cognitive burden on a user and produce a more efficient human-machine interface. For battery-operated computing devices, such methods and interfaces conserve power and increase the time between battery charges.

In some embodiments, a method that is performed at a computer system that is in communication with a display component, a respective device, one or more input devices, and a physical input mechanism is described. In some embodiments, the method comprises: after displaying a respective user interface: in accordance with a determination that the computer system will not be moving within a predetermined period of time, displaying, via the display component, a user interface object; and in accordance with a determination that the computer system will be moving within the predetermined period of time, forgoing displaying the user interface object; while displaying the user interface object, detecting, via the one or more input devices, a first input directed to the user interface object; and after detecting the first input directed to the user interface object, configuring the physical input mechanism to cause the respective device to perform a respective operation in response to detecting an input directed to the physical input mechanism.

In some embodiments, a non-transitory computer-readable storage medium storing one or more programs configured to be executed by one or more processors of a computer system that is in communication with a display component, a respective device, one or more input devices, and a physical input mechanism is described. In some embodiments, the one or more programs includes instructions for: after displaying a respective user interface: in accordance with a determination that the computer system will not be moving within a predetermined period of time, displaying, via the display component, a user interface object; and in accordance with a determination that the computer system will be moving within the predetermined period of time, forgoing displaying the user interface object; while displaying the user interface object, detecting, via the one or more input devices, a first input directed to the user interface object; and after detecting the first input directed to the user interface object, configuring the physical input mechanism to cause the respective device to perform a respective operation in response to detecting an input directed to the physical input mechanism.

In some embodiments, a transitory computer-readable storage medium storing one or more programs configured to be executed by one or more processors of a computer system that is in communication with a display component, a respective device, one or more input devices, and a physical input mechanism is described. In some embodiments, the one or more programs includes instructions for: after displaying a respective user interface: in accordance with a determination that the computer system will not be moving within a predetermined period of time, displaying, via the display component, a user interface object; and in accordance with a determination that the computer system will be moving within the predetermined period of time, forgoing displaying the user interface object; while displaying the user interface object, detecting, via the one or more input devices, a first input directed to the user interface object; and after detecting the first input directed to the user interface object, configuring the physical input mechanism to cause the respective device to perform a respective operation in response to detecting an input directed to the physical input mechanism.

In some embodiments, a computer system that is in communication with a display component, a respective device, one or more input devices, and a physical input mechanism is described. In some embodiments, the computer system that is in communication with a display component, a respective device, one or more input devices, and a physical input mechanism comprises one or more processors and memory storing one or more programs configured to be executed by the one or more processors. In some embodiments, the one or more programs includes instructions for: after displaying a respective user interface: in accordance with a determination that the computer system will not be moving within a predetermined period of time, displaying, via the display component, a user interface object; and in accordance with a determination that the computer system will be moving within the predetermined period of time, forgoing displaying the user interface object; while displaying the user interface object, detecting, via the one or more input devices, a first input directed to the user interface object; and after detecting the first input directed to the user interface object, configuring the physical input mechanism to cause the respective device to perform a respective operation in response to detecting an input directed to the physical input mechanism.

In some embodiments, a computer system that is in communication with a display component, a respective device, one or more input devices, and a physical input mechanism is described. In some embodiments, the computer system that is in communication with a display component, a respective device, one or more input devices, and a physical input mechanism comprises means for performing each of the following steps: after displaying a respective user interface: in accordance with a determination that the computer system will not be moving within a predetermined period of time, displaying, via the display component, a user interface object; and in accordance with a determination that the computer system will be moving within the predetermined period of time, forgoing displaying the user interface object; while displaying the user interface object, detecting, via the one or more input devices, a first input directed to the user interface object; and after detecting the first input directed to the user interface object, configuring the physical input mechanism to cause the respective device to perform a respective operation in response to detecting an input directed to the physical input mechanism.

In some embodiments, a computer program product is described. In some embodiments, the computer program product comprises one or more programs configured to be executed by one or more processors of a computer system that is in communication with a display component, a respective device, one or more input devices, and a physical input mechanism. In some embodiments, the one or more programs include instructions for: after displaying a respective user interface: in accordance with a determination that the computer system will not be moving within a predetermined period of time, displaying, via the display component, a user interface object; and in accordance with a determination that the computer system will be moving within the predetermined period of time, forgoing displaying the user interface object; while displaying the user interface object, detecting, via the one or more input devices, a first input directed to the user interface object; and after detecting the first input directed to the user interface object, configuring the physical input mechanism to cause the respective device to perform a respective operation in response to detecting an input directed to the physical input mechanism.

In some embodiments, a method that is performed at a computer system that is in communication with a display component, a respective device, and one or more input devices is described. In some embodiments, the method comprises: while navigating to a first destination: displaying, via the display component, a user interface object; and while displaying the user interface object, detecting, via one or more input devices, an input directed to the user interface object; in response to detecting the input directed to the user interface object: displaying, via the display component, a first indication; and navigating to a second destination instead of the first destination; and after displaying the first indication and in accordance with a determination that a set of one or more criteria is met, wherein the set of one or more criteria includes a criterion that is met when a determination is made that the computer system has reached a second destination, ceasing displaying the first indication.

In some embodiments, a non-transitory computer-readable storage medium storing one or more programs configured to be executed by one or more processors of a computer system that is in communication with a display component, a respective device, and one or more input devices is described. In some embodiments, the one or more programs includes instructions for: while navigating to a first destination: displaying, via the display component, a user interface object; and while displaying the user interface object, detecting, via one or more input devices, an input directed to the user interface object; in response to detecting the input directed to the user interface object: displaying, via the display component, a first indication; and navigating to a second destination instead of the first destination; and after displaying the first indication and in accordance with a determination that a set of one or more criteria is met, wherein the set of one or more criteria includes a criterion that is met when a determination is made that the computer system has reached a second destination, ceasing displaying the first indication.

In some embodiments, a transitory computer-readable storage medium storing one or more programs configured to be executed by one or more processors of a computer system that is in communication with a display component, a respective device, and one or more input devices is described. In some embodiments, the one or more programs includes instructions for: while navigating to a first destination: displaying, via the display component, a user interface object; and while displaying the user interface object, detecting, via one or more input devices, an input directed to the user interface object; in response to detecting the input directed to the user interface object: displaying, via the display component, a first indication; and navigating to a second destination instead of the first destination; and after displaying the first indication and in accordance with a determination that a set of one or more criteria is met, wherein the set of one or more criteria includes a criterion that is met when a determination is made that the computer system has reached a second destination, ceasing displaying the first indication.

In some embodiments, a computer system that is in communication with a display component, a respective device, and one or more input devices is described. In some embodiments, the computer system that is in communication with a display component, a respective device, and one or more input devices comprises one or more processors and memory storing one or more programs configured to be executed by the one or more processors. In some embodiments, the one or more programs includes instructions for: while navigating to a first destination: displaying, via the display component, a user interface object; and while displaying the user interface object, detecting, via one or more input devices, an input directed to the user interface object; in response to detecting the input directed to the user interface object: displaying, via the display component, a first indication; and navigating to a second destination instead of the first destination; and after displaying the first indication and in accordance with a determination that a set of one or more criteria is met, wherein the set of one or more criteria includes a criterion that is met when a determination is made that the computer system has reached a second destination, ceasing displaying the first indication.

In some embodiments, a computer system that is in communication with a display component, a respective device, and one or more input devices is described. In some embodiments, the computer system that is in communication with a display component, a respective device, and one or more input devices comprises means for performing each of the following steps: while navigating to a first destination: displaying, via the display component, a user interface object; and while displaying the user interface object, detecting, via one or more input devices, an input directed to the user interface object; in response to detecting the input directed to the user interface object: displaying, via the display component, a first indication; and navigating to a second destination instead of the first destination; and after displaying the first indication and in accordance with a determination that a set of one or more criteria is met, wherein the set of one or more criteria includes a criterion that is met when a determination is made that the computer system has reached a second destination, ceasing displaying the first indication.

In some embodiments, a computer program product is described. In some embodiments, the computer program product comprises one or more programs configured to be executed by one or more processors of a computer system that is in communication with a display component, a respective device, and one or more input devices. In some embodiments, the one or more programs include instructions for: while navigating to a first destination: displaying, via the display component, a user interface object; and while displaying the user interface object, detecting, via one or more input devices, an input directed to the user interface object; in response to detecting the input directed to the user interface object: displaying, via the display component, a first indication; and navigating to a second destination instead of the first destination; and after displaying the first indication and in accordance with a determination that a set of one or more criteria is met, wherein the set of one or more criteria includes a criterion that is met when a determination is made that the computer system has reached a second destination, ceasing displaying the first indication.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for displaying controls that are used to control one or more operations of a device, thereby increasing the effectiveness, efficiency, and user satisfaction with such devices. Such methods and interfaces may complement or replace other methods for displaying controls that are used to control one or more operations of a device.

### DESCRIPTION OF THE FIGURES

For a better understanding of the various described examples, reference should be made to the Detailed Description below, in conjunction with the following drawings in which like reference numerals refer to corresponding parts throughout the figures.

FIG. 1 is a block diagram illustrating a system with various components in accordance with some embodiments.

FIGS. 2A-2F illustrate exemplary user interfaces for controlling the operation of various systems of a computer system in accordance with some examples.

FIG. 3 is a flow diagram illustrating a method for configuring an input mechanism in accordance with some examples.

FIG. 4 is a flow diagram illustrating a method for displaying a user interface for controlling the navigation of a computer system in accordance with some examples.

### DETAILED DESCRIPTION

The following description sets forth exemplary techniques for displaying controls that are used to control one or more operations of a device. This description is not intended to limit the scope of this disclosure but is instead provided as a description of example implementations.

Users need electronic devices that provide effective techniques for displaying controls that are used to control one or more operations of a device. Efficient techniques can reduce a user's mental load when accessing controls that are used to control one or more operations of a device. This reduction in mental load can enhance user productivity and make the device easier to use. In some embodiments, the techniques described herein can reduce battery usage and processing time (e.g., by providing user interfaces that require fewer user inputs to operate).

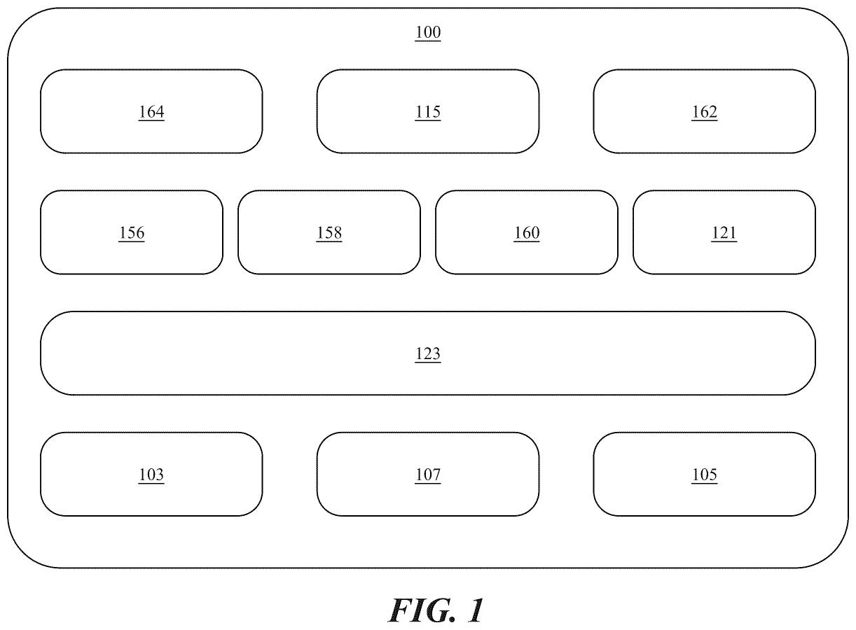

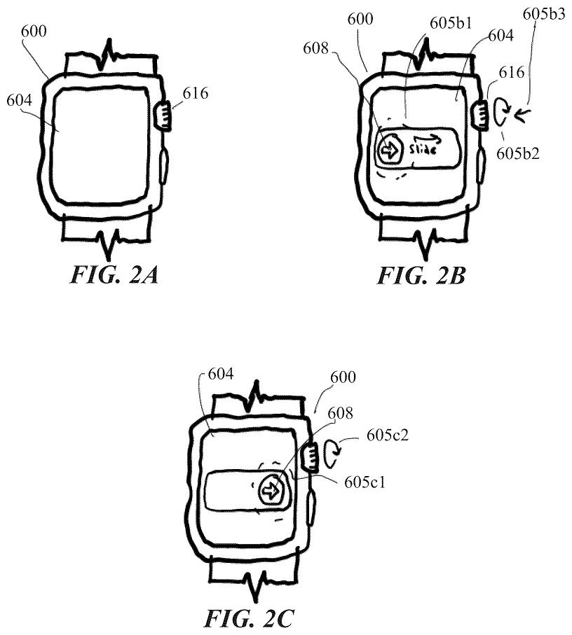

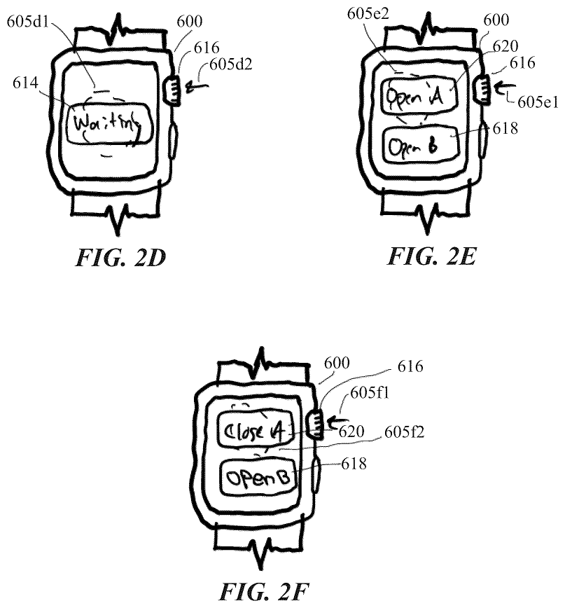

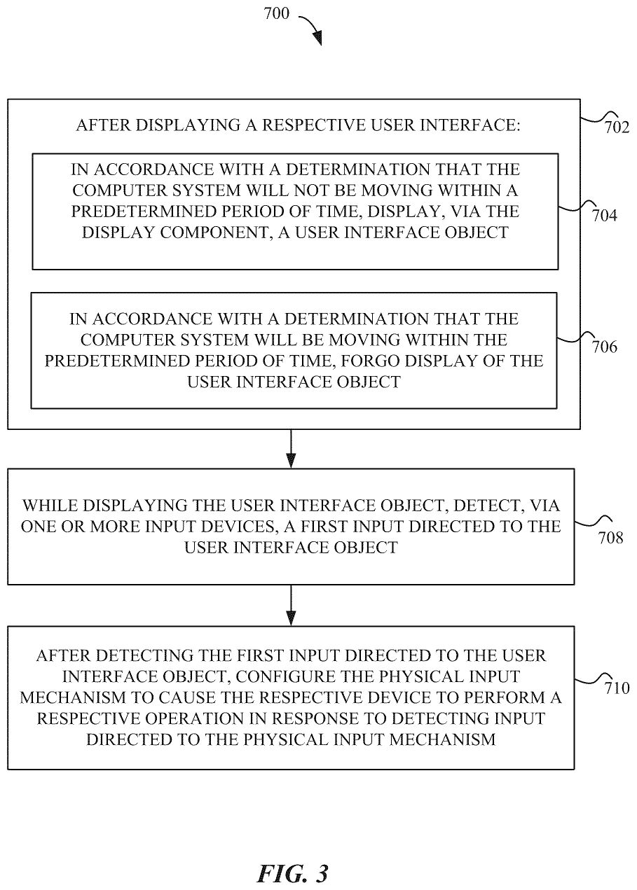

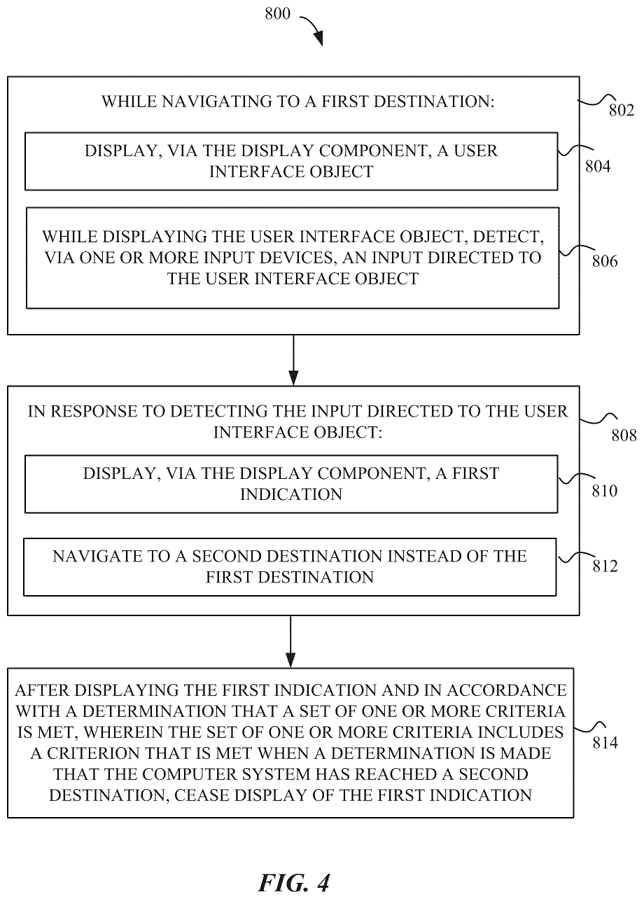

FIG. 1 provides illustrations of exemplary devices for performing techniques for displaying controls that are used to control one or more operations of a device. FIGS. 2A-2F illustrate exemplary user interfaces for controlling the operation of various systems of a computer system in accordance with some examples. FIG. 3 is a flow diagram illustrating methods of configuring a hardware input mechanism in accordance with some examples. FIG. 4 is a flow diagram illustrating methods of displaying a user interface for controlling the navigation of a computer system in accordance with some examples. The user interfaces in FIGS. 2A-2F are used to illustrate the processes described below, including the processes in FIGS. 3-4.

The processes below describe various techniques for making user interfaces and/or human-computer interactions more efficient (e.g., by helping the user to quickly and easily provide inputs and preventing user mistakes when operating a device). These techniques sometimes reduce the number of inputs needed for a user (e.g., a person and/or a user) to perform an operation, provide clear and/or meaningful feedback (e.g., visual, acoustic, and/or haptic feedback) to the user so that the user knows what has happened or what to expect, provide additional information and controls without cluttering the user interface, and/or perform certain operations without requiring further input from the user. Since the user can use a device more quickly and easily, these techniques sometimes improve battery life and/or reduce power usage of the device.

In methods described where one or more steps are contingent on one or more conditions having been satisfied, it should be understood that the described method can be repeated in multiple repetitions so that over the course of the repetitions all of the conditions upon which steps in the method are contingent have been satisfied in different repetitions of the method. For example, if a method requires performing a first step if a condition is satisfied, and a second step if the condition is not satisfied, it should be appreciated that the steps are repeated until the condition has been both satisfied and not satisfied, in no particular order. Thus, a method described with one or more steps that are contingent upon one or more conditions having been satisfied could be rewritten as a method that is repeated until each of the conditions described in the method has been satisfied. This multiple repetition, however, is not required of system or computer readable medium claims where the system or computer readable medium contains instructions for performing conditional operations that require that one or more conditions be satisfied before the operations occur. A person having ordinary skill in the art would also understand that, similar to a method with conditional steps, a system or computer readable storage medium can repeat the steps of a method as many times as are needed to ensure that all of the conditional steps have been performed.

The terminology used in the description of the various embodiments is for the purpose of describing particular embodiments only and is not intended to be limiting.

User interfaces for electronic devices, and associated processes for using these devices, are described below. In some embodiments, the device is a desktop computer with a touch-sensitive surface (e.g., a touch screen display and/or a touchpad). In other embodiments, the device is a portable, movable, and/or mobile electronic device (e.g., a processor, a smart phone, a smart watch, a tablet, a fitness tracking device, a laptop, a head-mounted display (HMD) device, a communal device, a vehicle, a media device, a smart speaker, a smart display, a robot, a television and/or a personal computing device).

In some embodiments, the electronic device is a computer system that is in communication with a display component (e.g., by wireless or wired communication). The display component may be integrated into the computer system or may be separate from the computer system. Additionally, the display component may be configured to provide visual output to a display (e.g., a liquid crystal display, an OLED display, or CRT display). As used herein, “displaying” content includes causing to display the content (e.g., video data rendered or decoded by a display controller) by transmitting, via a wired or wireless connection, data (e.g., image data or video data) to an integrated or external display component to visually produce the content. In some embodiments, visual output is any output that is capable of being perceived by the human eye, including, and not limited to images, videos, graphs, charts, and other graphical representations of data.

In some embodiments, the electronic device is a computer system that is in communication with an audio generation component (e.g., by wireless or wired communication). The audio generation component may be integrated into the computer system or may be separate from the computer system. Additionally, the audio generation component may be configured to provide audio output. Examples of an audio generation component include a speaker, a home theater system, a soundbar, a headphone, an earphone, an earbud, a television speaker, an augmented reality headset speaker, an audio jack, an optical audio output, a Bluetooth audio output, and/or an HDMI audio output). In some embodiments, audio output is any output that is capable of being perceived by the human ear, including, and not limited to sound waves, music, speech, and/or other audible representations of data.

In the discussion that follows, an electronic device that includes particular input and output devices is described. It should be understood, however, that the electronic device optionally includes one or more other input and/or output devices, such as physical user-interface devices (e.g., a physical keyboard, a mouse, and/or a joystick).

FIG. 1 illustrates an example system 100 for implementing techniques described herein. System 100 can perform any of the methods described in FIGS. 3 and/or 4 (e.g., processes 700 and/or 800) and/or portions of these methods.

In FIG. 1, system 100 includes various components, such as processor(s) 103, RF circuitry(ies) 105, memory (ies) 107, sensors 156 (e.g., image sensor(s), orientation sensor(s), location sensor(s), heart rate monitor(s), temperature sensor(s)), input device(s) 158 (e.g., camera(s) (e.g., a periscope camera, a telephoto camera, a wide-angle camera, and/or an ultra-wide-angle camera), depth sensor(s), microphone(s), touch sensitive surface(s), hardware input mechanism(s), and/or rotatable input mechanism(s)), mobility components (e.g., actuator(s) (e.g., pneumatic actuator(s), hydraulic actuator(s), and/or electric actuator(s)), motor(s), wheel(s), movable base(s), rotatable component(s), translation component(s), and/or rotatable base(s)) and output device(s) 160 (e.g., speaker(s), display component(s), audio generation component(s), haptic output device(s), display screen(s), projector(s), and/or touch-sensitive display(s)). These components optionally communicate over communication bus(es) 123 of the system. Although shown as separate components, in some implementations, various components can be combined and function as a single component, such as a sensor can be an input device.

In some embodiments, system 100 is a mobile and/or movable device (e.g., a tablet, a smart phone, a laptop, head-mounted display (HMD) device, and or a smartwatch). In other embodiments, system 100 is a desktop computer, an embedded computer, and/or a server.

In some embodiments, processor(s) 103 includes one or more general processors, one or more graphics processors, and/or one or more digital signal processors. In some embodiments, memory (ies) 107 is one or more non-transitory computer-readable storage mediums (e.g., flash memory and/or random-access memory) that store computer-readable instructions configured to be executed by processor(s) 103 to perform techniques described herein.

In some embodiments, RF circuitry(ies) 105 includes circuitry for communicating with electronic devices and/or networks (e.g., the Internet, intranets, and/or a wireless network, such as cellular networks and wireless local area networks (LANs)). In some embodiments, RF circuitry(ies) 105 includes circuitry for communicating using near-field communication and/or short-range communication, such as Bluetooth® or Ultra-wideband.

In some embodiments, display(s) 121 includes one or more monitors, projectors, and/or screens. In some embodiments, display(s) 121 includes a first display for displaying images to a first eye of a user and a second display for displaying images to a second eye of the user. In such embodiments, corresponding images can be simultaneously displayed on the first display and the second display. Optionally, the corresponding images include the same virtual objects and/or representations of the same physical objects from different viewpoints, resulting in a parallax effect that provides the user with the illusion of depth of the objects on the displays. In some embodiments, display(s) 121 is a single display. In such embodiments, corresponding images are simultaneously displayed in a first area and a second area of the single display for each eye of the user. Optionally, the corresponding images include the same virtual objects and/or representations of the same physical objects from different viewpoints, resulting in a parallax effect that provides a user with the illusion of depth of the objects on the single display.

In some embodiments, system 100 includes touch-sensitive surface(s) 115 for receiving user inputs, such as tap inputs and swipe inputs. In some embodiments, display(s) 121 and touch-sensitive surface(s) 115 form touch-sensitive display(s).

In some embodiments, sensor(s) 156 includes sensors for detecting various conditions. In some embodiments, sensor(s) 156 includes orientation sensors (e.g., orientation sensor(s) 111) for detecting orientation and/or movement of platform 150. For example, system 100 uses orientation sensors to track changes in the location and/or orientation (sometimes collectively referred to as position) of system 100, such as with respect to physical objects in the physical environment. In some embodiments, sensor(s) 156 includes one or more gyroscopes, one or more inertial measurement units, and/or one or more accelerometers. In some embodiments, sensor(s) 156 includes a global positioning sensor (GPS) for detecting a GPS location of platform 150. In some embodiments, sensor(s) 156 includes a radar system, LIDAR system, sonar system, image sensors (e.g., image sensor(s) 109, visible light image sensor(s), and/or infrared sensor(s)), depth sensor(s), rangefinder(s), and/or motion detector(s). In some embodiments, sensor(s) 156 includes sensors that are in an interior portion of system 100 and/or sensors that are on an exterior of system 100. In some embodiments, system 100 uses sensor(s) 156 (e.g., interior sensors) to detect a presence and/or state (e.g., location and/or orientation) of a passenger in the interior portion of system 100. In some embodiments, system 100 uses sensor(s) 156 (e.g., external sensors) to detect a presence and/or state of an object external to system 100. In some embodiments, system 100 uses sensor(s) 156 to receive user inputs, such as hand gestures and/or other air gesture. In some embodiments, system 100 uses sensor(s) 156 to detect the location and/or orientation of system 100 in the physical environment. In some embodiments, system 100 uses sensor(s) 156 to navigate system 100 along a planned route, around obstacles, and/or to a destination location. In some embodiments, sensor(s) 156 include one or more sensors for identifying and/or authenticating a user of system 100, such as a fingerprint sensor and/or facial recognition sensor.

In some embodiments, image sensor(s) includes one or more visible light image sensor, such as charged coupled device (CCD) sensors, and/or complementary metal-oxide-semiconductor (CMOS) sensors operable to obtain images of physical objects. In some embodiments, image sensor(s) includes one or more infrared (IR) sensor(s), such as a passive IR sensor or an active IR sensor, for detecting infrared light. For example, an active IR sensor can include an IR emitter, such as an IR dot emitter, for emitting infrared light. In some embodiments, image sensor(s) includes one or more camera(s) configured to capture movement of physical objects. In some embodiments, image sensor(s) includes one or more depth sensor(s) configured to detect the distance of physical objects from system 100. In some embodiments, system 100 uses CCD sensors, cameras, and depth sensors in combination to detect the physical environment around system 100. In some embodiments, image sensor(s) includes a first image sensor and a second image sensor different form the first image sensor. In some embodiments, system 100 uses image sensor(s) to receive user inputs, such as hand gestures and/or other air gestures. In some embodiments, system 100 uses image sensor(s) to detect the location and/or orientation of system 100 in the physical environment.

In some embodiments, system 100 uses orientation sensor(s) for detecting orientation and/or movement of system 100. For example, system 100 can use orientation sensor(s) to track changes in the location and/or orientation of system 100, such as with respect to physical objects in the physical environment. In some embodiments, orientation sensor(s) includes one or more gyroscopes, one or more inertial measurement units, and/or one or more accelerometers.

In some embodiments, system 100 uses microphone(s) to detect sound from one or more users and/or the physical environment of the one or more users. In some embodiments, microphone(s) includes an array of microphones (including a plurality of microphones) that optionally operate in tandem, such as to identify ambient noise or to locate the source of sound in space (e.g., inside system 100 and/or outside of system 100) of the physical environment.

In some embodiments, input device(s) 158 includes one or more mechanical and/or electrical devices for detecting input, such as button(s), slider(s), knob(s), switch(es), remote control(s), joystick(s), touch-sensitive surface(s), keypad(s), microphone(s), and/or camera(s). In some embodiments, input device(s) 158 include one or more input devices inside system 100. In some embodiments, input device(s) 158 include one or more input devices (e.g., a touch-sensitive surface and/or keypad) on an exterior of system 100.

In some embodiments, output device(s) 160 include one or more devices, such as display(s), monitor(s), projector(s), speaker(s), light(s), and/or haptic output device(s). In some embodiments, output device(s) 160 includes one or more external output devices, such as external display screen(s), external light(s), and/or external speaker(s). In some embodiments, output device(s) 160 includes one or more internal output devices, such as internal display screen(s), internal light(s), and/or internal speaker(s).

In some embodiments, environment controls 162 includes mechanical and/or electrical systems for monitoring and/or controlling conditions of an internal portion (e.g., cabin) of system 100. In some embodiments, environment controls 162 includes fan(s), heater(s), air conditioner(s), and/or thermostat(s) for controlling the temperature and/or airflow within the interior portion of system 100.

In some embodiments, mobility component(s) includes mechanical and/or electrical components that enable a platform to move and/or assist in the movement of the platform. In some embodiments, mobility system 164 includes powertrain(s), drivetrain(s), motor(s) (e.g., an electrical motor), engine(s), power source(s) (e.g., battery (ies)), transmission(s), suspension system(s), speed control system(s), and/or steering system(s). In some embodiments, one or more elements of mobility component(s) are configured to be controlled autonomously or manually (e.g., via system 100 and/or input device(s) 158).

In some embodiments, system 100 performs monetary transactions with or without another computer system. For example, system 100, or another computer system associated with and/or in communication with system 100 (e.g., via a user account described below), is associated with a payment account of a user, such as a credit card account or a checking account. To complete a transaction, system 100 can transmit a key to an entity from which goods and/or services are being purchased that enables the entity to charge the payment account for the transaction. As another example, system 100 stores encrypted payment account information and transmits this information to entities from which goods and/or services are being purchased to complete transactions.

System 100 optionally conducts other transactions with other systems, computers, and/or devices. For example, system 100 conducts transactions to unlock another system, computer, and/or device and/or to be unlocked by another system, computer, and/or device. Unlocking transactions optionally include sending and/or receiving one or more secure cryptographic keys using, for example, RF circuitry(ies) 105.

In some embodiments, system 100 is capable of communicating with other computer systems and/or electronic devices. For example, system 100 can use RF circuitry(ies) 105 to access a network connection that enables transmission of data between systems for the purpose of communication. Example communication sessions include phone calls, e-mails, SMS messages, and/or videoconferencing communication sessions.

In some embodiments, videoconferencing communication sessions include transmission and/or receipt of video and/or audio data between systems participating in the videoconferencing communication sessions, including system 100. In some embodiments, system 100 captures video and/or audio content using sensor(s) 156 to be transmitted to the other system(s) in the videoconferencing communication sessions using RF circuitry(ies) 105. In some embodiments, system 100 receives, using the RF circuitry(ies) 105, video and/or audio from the other system(s) in the videoconferencing communication sessions, and presents the video and/or audio using output device(s) 160, such as display(s) 121 and/or speaker(s). In some embodiments, the transmission of audio and/or video between systems is near real-time, such as being presented to the other system(s) with a delay of less than 0.1, 0.5, 1, or 3 seconds from the time of capturing a respective portion of the audio and/or video.

In some embodiments, the system 100 generates tactile (e.g., haptic) outputs using output device(s) 160. In some embodiments, output device(s) 160 generates the tactile outputs by displacing a moveable mass relative to a neutral position. In some embodiments, tactile outputs are periodic in nature, optionally including frequency (ies) and/or amplitude(s) of movement in two or three dimensions. In some embodiments, system 100 generates a variety of different tactile outputs differing in frequency (ies), amplitude(s), and/or duration/number of cycle(s) of movement included. In some embodiments, tactile output pattern(s) includes a start buffer and/or an end buffer during which the movable mass gradually speeds up and/or slows down at the start and/or at the end of the tactile output, respectively.

In some embodiments, tactile outputs have a corresponding characteristic frequency that affects a “pitch” of a haptic sensation that a user feels. For example, higher frequency (ies) corresponds to faster movement(s) by the moveable mass whereas lower frequency (ies) corresponds to slower movement(s) by the moveable mass. In some embodiments, tactile outputs have a corresponding characteristic amplitude that affects a “strength” of the haptic sensation that the user feels. For example, higher amplitude(s) corresponds to movement over a greater distance by the moveable mass, whereas lower amplitude(s) corresponds to movement over a smaller distance by the moveable mass. In some embodiments, the “pitch” and/or “strength” of a tactile output varies over time.

In some embodiments, tactile outputs are distinct from movement of system 100. For example, system 100 can includes tactile output device(s) that move a moveable mass to generate tactile output and can include other moving part(s), such as motor(s), wheel(s), axel(s), control arm(s), and/or brakes that control movement of system 100. Although movement and/or cessation of movement of system 100 generates vibrations and/or other physical sensations in some situations, these vibrations and/or other physical sensations are distinct from tactile outputs. In some embodiments, system 100 generates tactile output independent from movement of system 100 For example, system 100 can generate a tactile output without accelerating, decelerating, and/or moving system 100 to a new position.

In some embodiments, system 100 detects gesture input(s) made by a user. In some embodiments, gesture input(s) includes touch gesture(s) and/or air gesture(s), as described herein. In some embodiments, touch-sensitive surface(s) 115 identify touch gestures based on contact patterns (e.g., different intensities, timings, and/or motions of objects touching or nearly touching touch-sensitive surface(s) 115). Thus, touch-sensitive surface(s) 115 detect a gesture by detecting a respective contact pattern. For example, detecting a finger-down event followed by detecting a finger-up (e.g., liftoff) event at (e.g., substantially) the same position as the finger-down event (e.g., at the position of a user interface element) can correspond to detecting a tap gesture on the user interface element. As another example, detecting a finger-down event followed by detecting movement of a contact, and subsequently followed by detecting a finger-up (e.g., liftoff) event can correspond to detecting a swipe gesture. Additional and/or alternative touch gestures are possible.

In some embodiments, an air gesture is a gesture that a user performs without touching input device(s) 158. In some embodiments, air gestures are based on detected motion of a portion (e.g., a hand, a finger, and/or a body) of a user through the air. In some embodiments, air gestures include motion of the portion of the user relative to a reference. Example references include a distance of a hand of a user relative to a physical object, such as the ground, an angle of an arm of the user relative to the physical object, and/or movement of a first portion (e.g., hand or finger) of the user relative to a second portion (e.g., shoulder, another hand, or another finger) of the user. In some embodiments, detecting an air gesture includes detecting absolute motion of the portion of the user, such as a tap gesture that includes movement of a hand in a predetermined pose by a predetermined amount and/or speed, or a shake gesture that includes a predetermined speed or amount of rotation of a portion of the user.

In some embodiments, detecting one or more inputs includes detecting speech of a user. In some embodiments, system 100 uses one or more microphones of input device(s) 158 to detect the user speaking one or more words. In some embodiments, system 100 parses and/or communicates information to one or more other systems to determine contents of the speech of the user, including identifying words and/or obtaining a semantic understanding of the words. For example, processor(s) 103 can be configured to perform natural language processing to detect one or more words and/or determine a likely meaning of the one or more words in the sequence spoken by the user. Additionally or alternatively, in some embodiments, the system 100 determines the meaning of the one or more words in the sequence spoken based upon a context of the user determined by the system 100.

In some embodiments, system 100 outputs spatial audio via output device(s) 160. In some embodiments, spatial audio is output in a particular position. For example, system 100 can play a notification chime having one or more characteristics that cause the notification chime to be generated as if emanating from a first position relative to a current viewpoint of a user (e.g., “spatializing” and/or “spatialization” including audio being modified in amplitude, filtered, and/or delayed to provide a perceived spatial quality to the user).

In some embodiments, system 100 presents visual and/or audio feedback indicating a position of a user relative to a current viewpoint of another user, thereby informing the other user about an updated position of the user. In some embodiments, playing audio corresponding to a user includes changing one or more characteristics of audio obtained from another computer system to mimic an effect of placing an audio source that generates the play back of audio within a position corresponding to the user, such as a position within a three-dimensional environment that the user moves to, spawns at, and/or is assigned to. In some embodiments, a relative magnitude of audio at one or more frequencies and/or groups of frequencies is changed, one or more filters are applied to audio (e.g., directional audio filters), and/or the magnitude of audio provided via one or more channels are changed (e.g., increased or decreased) to create the perceived effect of the physical audio source. In some embodiments, the simulated position of the simulated audio source relative to a floor of the three-dimensional environment matches an elevation of a head of a participant providing audio that is generated by the simulated audio source, or is a predetermined one or more elevations relative to the floor of the three-dimensional environment. In some embodiments, in accordance with a determination that the position of the user will correspond to a second position, different from the first position, and that one or more first criteria are satisfied, system 100 presents feedback including generating audio as if emanating from the second position.

In some embodiments, system 100 communicates with one or more accessory devices. In some embodiments, one or more accessory devices is integrated with system 100. In some embodiments, one or more accessory devices is external to system 100. In some embodiments, system 100 communicates with accessory device(s) using RF circuitry(ies) 105 and/or using a wired connection. In some embodiments, system 100 controls operation of accessory device(s), such as door(s), window(s), lock(s), speaker(s), light(s), and/or camera(s). For example, system 100 can control operation of a motorized door of system 100. As another example, system 100 can control operation of a motorized window included in system 100. In some embodiments, accessory device(s), such as remote control(s) and/or other computer systems (e.g., smartphones, media players, tablets, computers, and/or wearable devices) functioning as input devices control operations of system 100. For example, a wearable device (e.g., a smart watch) functions as a key to initiate operation of an actuation system of system 100. In some embodiments, system 100 acts as an input device to control operations of another system, device, and/or computer, such as system 100 functioning as a key to initiate operation of an actuation system of a platform associated with another system, device, and/or computer.

In some embodiments, digital assistant(s) help a user perform various functions using system 100. For example, a digital assistant can provide weather updates, set alarms, and perform searches locally and/or using a network connection (e.g., the Internet) via a natural-language interface. In some embodiments, a digital assistant accepts requests at least partially in the form of natural language commands, narratives, requests, statements, and/or inquiries. In some embodiments, a user requests an informational answer and/or performance of a task using the digital assistant. For example, in response to receiving the question “What is the current temperature?,” the digital assistant answers “It is 30 degrees.” As another example, in response to receiving a request to perform a task, such as “Please invite my family to dinner tomorrow,” the digital assistant can acknowledge the request by playing spoken words, such as “Yes, right away,” and then send the requested calendar invitation on behalf of the user to each family member of the user listed in a contacts list for the user. In some embodiments, during performance of a task requested by the user, the digital assistant engages with the user in a sustained conversation involving multiple exchanges of information over a period of time. Other ways of interacting with a digital assistant are possible to request performance of a task and/or request information. For example, the digital assistant can respond to the user in other forms, e.g., displayed alerts, text, videos, animations, music, etc. In some embodiments, the digital assistant includes a client-side portion executed on system 100 and a server-side portion executed on a server in communication with system 100. The client-side portion can communicate with the server through a network connection using RF circuitry(ies) 105. The client-side portion can provide client-side functionalities, input and/or output processing and/or communication with the server, for example. In some embodiments, the server-side portion provides server-side functionalities for any number client-side portions of multiple systems.

In some embodiments, system 100 is associated with one or more user accounts. In some embodiments, system 100 saves and/or encrypts user data, including files, settings, and/or preferences in association with particular user accounts. In some embodiments, user accounts are password-protected and system 100 requires user authentication before accessing user data associated with an account. In some embodiments, user accounts are associated with other system(s), device(s), and/or server(s). In some embodiments, associating one user account with multiple systems enables those systems to access, update, and/or synchronize user data associated with the user account. For example, the systems associated with a user account can have access to purchased media content, a contacts list, communication sessions, payment information, saved passwords, and other user data. Thus, in some embodiments, user accounts provide a secure mechanism for a customized user experience.

Attention is now directed towards embodiments of user interfaces (“UI”) and associated processes that are implemented on an electronic device, such as system 100.

FIGS. 2A-2F illustrate exemplary user interfaces for controlling the operation of various systems of a computer system. The user interfaces in these figures are used to illustrate the processes described below, including the processes described below in relation to FIGS. 3-4. In some embodiments, FIGS. 2A-2F are provided to illustrate an example, where one or more controls for a computer system are not accessed and are harder to access (e.g., require an additional input) while the computer system is operating in a certain state (e.g., moving) as opposed to while the computer system is operating in a different state (e.g., not moving). In some embodiments, FIGS. 2A-2F are provided to illustrate an example where a hardware input mechanism (e.g., rotatable input mechanism) is not configured to be used to cause an operation to be performed while the computer system is operating in a certain state (e.g., moving) as opposed to being configured to be used to cause an operation to be performed while the computer system is operating in a different state (e.g., not moving). In some embodiments, limiting the accessibility of one or more controls and/or not allowing the hardware input mechanism to be configured while operating in the certain state increases safety of an external structure and/or computer system, such that one or more operations (e.g., such as opening a door) are prevented to be performed while the computer system is moving. In some embodiments, FIGS. 2A-2F illustrate other examples and/or concepts, as described below, in addition to and/or in lieu of the immediate examples provided above and/or one or more other benefits can be realized in addition to those described herein.

FIG. 2A illustrates computer system 600, which is a smartwatch and includes display 604 (e.g., a display component) and rotatable input mechanism 616. In some embodiments, computer system 600 includes one or more components of system 100 described above. In some embodiments, computer system 600 is coupled to an external structure (e.g., a boat, an airplane, a car, and/or a trailer). In some embodiments, the external structure includes two or more doors and encases one or more external sensors, components, and/or modules. In some embodiments, the external structure is computer system 600. It should be understood that the types of computer systems, user interfaces, user interface objects, and components described herein are merely exemplary and are provided to give context to the embodiments described herein.

In some embodiments, computer system 600 is coupled to an external structure (e.g., a boat, an airplane, a car, and/or a trailer) that includes two or more doors. In some embodiments, computer system 600 is in communication (e.g., wired and/or wireless (e.g., Wi-Fi, Bluetooth, and/or ultra-wideband) communication) with the two or more doors (covering, windows, etc.) of the external structure. In some embodiments, computer system 600 includes a knob, a dial, a joystick, a touch-sensitive surface, a button, a slider, a television, a projector, a monitor, a smart display, a laptop, and/or a personal computer. In some embodiments, display 604 is positioned within rotatable input mechanism 616, such as display 604 is a display of rotatable input mechanism 616. In some embodiments, display 604 is positioned above or below rotatable input mechanism 616. In some embodiments, display 604 is positioned around rotatable input mechanism 616. In some embodiments, rotatable input mechanism 616 is positioned on the surface of display 604.

At FIG. 2A, the external structure is navigating to a first destination (e.g., the external structure is enroute to the first destination) and a determination is made that a set of criteria is satisfied. In some embodiments, the set of criteria is a set of stopping criteria that is directed to making a determination that the external structure will stop within a predetermined period of time, is about to, and/or is stopped (or paused). In some embodiments, the set of criteria is a set of reduced power criteria that is directed to making a determination that the external structure will transition from a first power mode to a mode that is configured to and/or uses less power than the external structure uses in the first power mode. In some embodiments, the set of criteria includes a criterion that is satisfied when a determination is made that the external structure is within a first distance threshold (e.g., .25, .5, .75, 1, 3, or 5 miles) of a point of interest. In some embodiments, the set of criteria includes a criterion that is satisfied when a determination is made that the external structure will go from one movement state (e.g., moving at a certain rate, not moving, a non-moving state, a moving state, moving some, and/or not moving at all) to a different movement state. In some embodiments, the set of criteria includes a criterion that is satisfied when a battery level of the external structure is below a predetermined battery level.

As illustrated in FIG. 2B, because the determination is made that the set of criteria is satisfied, computer system 600 displays control unlock user interface object 608. As illustrated in FIG. 2B, computer system 600 displays control unlock user interface object on a left portion of display 604. As described in greater detail below, selection of control unlock user interface object 608 initiates a process corresponding to one or more doors of the external structure. While displaying unlock user interface object 608 at FIG. 2B, the external structure remains enroute to the first destination. In some embodiments, computer system 600 displays a respective user interface prior to displaying unlock user interface object 608, such as a settings user interface. In some embodiments, the settings user interface includes one or more settings for changing the state of different external devices (e.g., devices external to computer system 600), but internal, In some embodiments, to the external structure, such as a thermostat, a light, a fan, and/or a window. In some embodiments, the external structure contains multiple computer system (e.g., like computer system 600) that are on different sides of the external structure, where the different computer systems on different sides of the external structure can be used to control the external devices on different sides of computer system 600 (e.g., devices on the right side and/or driver's side versus devices on the left side and/or passenger's side of the external structure).

At FIG. 2B, computer system 600 detects input 605b1 that corresponds to a rightward swipe on control unlock user interface object 608 and/or detects rotation input 605b2 on rotatable input mechanism 616. In some embodiments, input 605b1 corresponds to another type of input, such as a tap input, a voice command, a gaze, an air gesture, and/or a long press (e.g., a tap and hold input that is detected for more than a threshold amount of time). In some embodiments, input 605b1 corresponds to a vertical swipe input (e.g., an upward swipe input and/or a downward swipe input) and/or a diagonal swipe input.

In some embodiments, computer system 600 ceases to display control unlock user interface object 608 when a determination is made that the external structure transitions from being located at a distance from the point of interest that is less than the first distance threshold to being located at a distance from the point of interest that is greater than the first distance threshold (e.g., the external structure is moving away from the point of interest). In some embodiments, computer system 600 ceases to display unlock user interface object 608 when a determination is made that the external structure transitions from a moving state to a non-moving state. In some embodiments, computer system 600 ceases to display unlock user interface object 608 when a determination is made that computer system 600 has been rerouted and/or the set of criteria (e.g., discussed above in relation to FIG. 2A) is no longer satisfied.

At FIG. 2C, computer system 600 moves the display of control unlock user interface object 608 in response to detecting movement of input 605b1 and/or rotation input 605b2. At FIG. 2C, computer system 600 moves the display of control unlock user interface object 608 from the left portion of display 604 to the right portion of display 604 because input 605b1 moves from left to right. At FIG. 2C, the external structure remains enroute to the first destination, and computer system 600 ceases to detect input 605b1. In some embodiments, computer system 600 moves the display of control unlock user interface object 608 in response to detecting rotation input 605b2 (e.g., as illustrated in FIG. 2B) that corresponds to a rotation of rotatable input mechanism 616. In some embodiments, computer system 600 moves the display of control unlock user interface object 608 in response to detecting press input 605b3 (e.g., as illustrated in FIG. 2B) that corresponds to a depression of rotatable input mechanism 616.

At FIG. 2D, in response to computer system 600 ceasing to detect input 605b1 (or ceasing to detect rotation input 605b2 or press input 605b3), computer system 600 transmits instructions to the external structure that cause the external structure to transition from navigating to the first destination to navigating to a second destination (e.g., that is different than the first destination) (e.g., the external structure is re-routed). Here, the second destination is determined to be a safe destination for the external structure (e.g., the external structure will not impede traffic while the external structure is at the second destination and/or the second destination is designated as a stopping point for different types of external structures). Additionally, at FIG. 2D, a determination is made that the external structure is located at a distance from the second destination that is greater than a second distance threshold (e.g., . 25, 5, .75, 1, 3, or 5 miles). In response to ceasing to detect input 605b1 (or ceasing to detect rotation input 605b2 or press input 605b3) and because a determination is made that the external structure is located at a distance from the second destination that is greater than the second distance threshold, computer system 600 displays wait indication user interface object 614 and ceases to display control unlock user interface object 608. Computer system 600 displays wait indication user interface object 614 while the external structure is located at a distance from the second destination that is greater than the second distance threshold. In some embodiments, in response to computer system 600 ceasing to detect input 605b1, computer system 600 transmits instructions to a sub-component of external structure that cause the external structure to transition from navigating to the first destination to navigating to a second destination. In some embodiments, computer system 600 initiates a process that causes the external structure to transition from a moving state to a non-moving (e.g., a static and/or non-operating) state in response to computer system 600 ceasing to detect input 605b1. In some embodiments, computer system 600 ceases to display wait indication user interface object 614 when a determination is made that the external structure does not arrive at the second destination within a predetermined amount of time (e.g., 1, 3, 5, 10, 15, 25, or 30 minutes). In some embodiments, computer system 600 ceases to display wait indication user interface object 614 when a determination is made that the external structure receives a request to transition from navigating to the second destination to navigating to a third destination. In some embodiments, the external structure does not transition from navigating to the first destination to navigating to the second destination if computer system 600 does not detect input 605b1. In some embodiments, computer system 600 displays wait indication user interface object 614 when a determination is made that the external structure is in route to the second destination. In some embodiments, computer system 600 does not perform an operation in response to detecting input 605dl that corresponds to selection of wait indication user interface object 614. In some embodiments, while computer system 600 displays wait indication user interface object 614, computer system 600 does not perform an operation in response to detecting input 605d2 that corresponds to selection of rotatable input mechanism 616 (e.g., because a determination is made that the external structure and/or computer system 600 is moving). In some embodiments, wait indication user interface object 614 is displayed to indicate that a requested operation (e.g., opening a door) cannot be caused to be performed and/or that the external structure is not in a state that allows the requested operation to be performed and/or to be caused to be performed.

At FIG. 2E, a determination is made that a second set of criteria is satisfied. In some embodiments, the second set of criteria is satisfied when a determination is made that the external structure transitions from being at a distance from the second destination that is greater than the second distance threshold to being at a distance from the second destination is less than the second distance threshold. In some embodiments, the second set of criteria is satisfied when a determination is made that the external structure has stopped. In some embodiments, the second set of criteria is satisfied when a determination is made that the external structure is in a safer position and/or state.

At FIG. 2E, because the second set of criteria is satisfied, computer system 600 ceases to display wait indication user interface object 614 and displays Door B control user interface object 618 and Door A control user interface object 620. Door B control user interface object 618 corresponds to Door B of the external structure and Door A control user interface object 620 corresponds to Door A of the external structure.

Further, at FIG. 2E, a determination is made that the user is positioned closer to Door A of the external structure than Door B of the external structure. Because determinations are made that the user (or computer system 600) is positioned closer to Door A of the external structure than Door B of the external structure and that the external structure transitions from being at a distance from the second destination that is greater than the second distance threshold to being at a distance from the second destination is less than the second distance threshold, computer system 600 configures rotatable input mechanism 616 to control Door A. In some embodiments, computer system 600 unconfigures rotatable input mechanism 616 from controlling Door A when a determination that the external structure transitions from a non-moving state to a moving state. In some embodiments, is made computer system 600 configures rotatable input mechanism 616 to control Door A of the external structure when a determination is made that the external structure arrives at the second destination and when a determination is made that the user is positioned closer to Door A of the external structure than of the external structure. In some embodiments, computer system 600 does not configure rotatable input mechanism 616 to control Door B and/or Door A of the external structure while the external structure is moving. In some embodiments, computer system 600 does not configure rotatable input mechanism 616 to control Door B and/or Door A of the external structure while computer system 600 displays wait indication user interface object 614.

At FIG. 2E a determination is made that Door B and Door A of the external structure are closed. Because a determination is made that the Door A and Door B of the external structure are closed, computer system 600 displays Door B control user interface object 618 and Door A control user interface object 620 with an indication that Door B and Door A of the external structure can be opened. That is, computer system 600 displays Door B control user interface object 618 with an indication of the current state and/or position of Door B and computer system 600 displays Door A control user interface object 620 with an indication of the current state and/or position of Door A. In some embodiments, computer system 600 visually emphasizes (e.g., highlights) Door B control user interface object 618 when a determination is made that the user is positioned closer to Door B of the external structure than Door A of the external structure and de-emphasizes Door A control user interface object 620 when a determination is made that the user is positioned closer to Door B of the external structure than Door A of the external structure or vice versa. In some embodiments, computer system 600 scrolls between Door B control user interface object 618 and Door A control user interface object 620 in response to detecting an input that corresponds to rotation of rotatable input mechanism 616. At FIG. 2E, computer system 600 detects input 605e1 that corresponds to selection of rotatable input mechanism 616. In some embodiments, input 605e1 corresponds to a voice command, a gaze, and/or a long press (e.g., a tap and hold). At FIG. 2F, a determination is made that the user is positioned closer to Door A of the external structure than Door B of the external structure. Further, at FIG. 2F, a determination is made that Door A of the external structure is closed. Because determinations are made that that the user is positioned closer to Door A of the external structure than Door B of the external structure and that Door A of the external structure is closed, in response to detecting input 605e1, computer system 600 transmits instructions to Door A that cause Door A of the external structure to open. In some embodiments, after computer system 600 transmits instructions to Door A of the external structure that cause Door A of the external structure to open, computer system 600 configures rotatable input mechanism 616 to close Door A of the external structure. In some embodiments, while rotatable input mechanism 616 is configured to close Door A of the external structure, computer system 600 transmits instructions to Door A that cause Door A to close in response to detecting input 605f1 that corresponds to selection of rotatable input mechanism 616. In some embodiments, computer system 600 transmits instructions to Door A that cause Door A to close in response to detecting input 605f2 that corresponds to selection of Door A control user interface object 620. In some embodiments, in response to detecting input 605e1 and when a determination is made that the user is positioned closer to Door A of the external structure than Door B of the external structure and that Door A of the external structure is open, computer system 600 transmits instructions to Door A that cause Door A to close. In some embodiments, computer system 600 does not transit instructions to Door A (or the Door B) that cause Door A to open when a determination is made that the external structure is moving (e.g., such as when input 605d2 is detected at FIG. 2D). In some embodiments, in response to detecting input 605e1, computer system 600 transmits instructions to a respective door of the external structure that cause the respective door to open or close based on the display location of control unlock user interface object 608 (e.g., if computer system 600 displays control unlock user interface object 608 on a left portion of display 604, computer system 600 transmits the instructions to a door on the left side of the external structure or if computer system 600 displays control unlock user interface object 608 on a right portion of display 604, computer system 600 transmits the instructions to a door on the right side of the external structure). In some embodiments, computer system 600 transmits instructions to Door A that cause Door A of the external structure to open in response to detecting input 605e2 (e.g., as illustrated in FIG. 2E) that corresponds to selection of Door A control user interface object 620. In some embodiments, in response to detecting input 605e1, computer system 600 transmits instructions to an actuator of (e.g., that controls movement of and/or controls) Door A that cause the actuator to open Door A.

At FIG. 2F, a determination is made that Door A of the external structure is open and a determination is made that Door B of the external structure remains closed. As illustrated in FIG. 2F, because a determination is made that Door A of the external structure is open, computer system 600 displays Door A control user interface object 620 with an indication that Door A can be closed. Further, as illustrated in FIG. 2F, because a determination is made that Door B of the external structure is closed, computer system 600 displays Door B control user interface object 618 with an indication that Door B can be opened. In some embodiments, in response to detecting input 605e1, computer system 600 transmits instructions to Door B and Door A that cause both Door B and Door A to open. In some embodiments, in response to detecting input 605f1 and when a determination is made that computer system 600 is positioned closer to Door A of the external structure than Door B of the external structure, computer system 600 transmits instructions to Door A that cause Door A to close. In some embodiments, while both Door B and Door A of the external structure are open, in response to detecting an input directed at rotatable input mechanism 616, computer system 600 transmits instructions to both Door B and Door A of the external structure that cause Door B and Door A to close.

FIG. 3 is a flow diagram illustrating a method (e.g., process 700) for configuring an input mechanism in accordance with some examples. Some operations in process 700 are, optionally, combined, the orders of some operations are, optionally, changed, and some operations are, optionally, omitted.

As described below, process 700 provides an intuitive way for configuring an input mechanism. Process 700 reduces the cognitive burden on a user for configuring an input mechanism, thereby creating a more efficient human-machine interface. For battery-operated computing devices, enabling a user to configure an input mechanism faster and more efficiently conserves power and increases the time between battery charges.

In some embodiments, process 700 is performed at a computer system (e.g., 600) that is in communication with a display component (e.g., 604) (e.g., a display screen and/or a touch-sensitive display), a respective device (e.g., a watch, a phone, a tablet, a processor, a head-mounted display (HMD) device, and/or a personal computing device, an actuator for a window and/or a door), one or more input devices (e.g., 604 and/or 616) (e.g., a physical input mechanism, a camera, a touch-sensitive display, a microphone, and/or a button), and a physical input mechanism (e.g., 616) (e.g., a rotatable input mechanism and/or a button) (e.g., a hardware input mechanism and/or a physical portion of the computer system). In some embodiments, the computer system is a watch, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras). In some embodiments, the respective device is external to the computer system. In some embodiments, the respective device is a part of the computer system. In some embodiments, the computer system includes the respective device. In some embodiments, the computer system does not include the respective device.

After (702) (and/or while) displaying a respective user interface and in accordance with a determination that the computer system (e.g., 600) will not be moving within a predetermined period of time (e.g., 1-120 seconds), the computer system displays (704), via the display component (e.g., 604), a user interface object (e.g., 618 and/or 620). In some embodiments, in accordance with a determination that the computer system will not be moving within the predetermined period of time, the computer system ceases to display the respective user interface. In some embodiments, the determination that the computer system will not be moving within the predetermined period of time includes a determination that the computer system is within a predetermined distance from a destination. In some embodiments, the determination that the computer system will not be moving within the predetermined period of time includes a determination that the computer system is within a predetermined amount of time from a destination.

After (702) displaying the respective user interface and in accordance with a determination that the computer system (e.g., 600) will be moving within the predetermined period of time, the computer system forgoes (706) displaying the user interface object (e.g., 618 and/or 620). In some embodiments, in accordance with a determination that the computer system will not be moving within a predetermined period of time, the computer system continues to display the respective user interface. In some embodiments, in accordance with a determination that the computer system will be moving within the predetermined period of time, the computer system ceases displaying the user interface object.

While displaying the user interface object (618 and/or 620), the computer system detects (708), via the one or more input devices (e.g., 604 and/or 616), a first input (e.g., 605e1, 605e2, 605f1, and/or 605f2) (e.g., a dragging and/or sliding input and, In some embodiments, a non-dragging and/or sliding input, such as a gaze input that moves, an air gesture that moves, a mouse click-and-drag input, and/or a rotational input) directed to the user interface object (e.g., an input that moves from a first position (e.g., that corresponds to a first position on the user interface object) to a second position (e.g., that corresponds to a second position on the user interface object), where the first position is different from the second position).

After (e.g., in response to) detecting the first input (e.g., 605e1, 605e2, 605f1, and/or 605f2) directed to the user interface object (618 and/or 620) (e.g., in response to a determination that the computer system is stopped (e.g., or within a predetermined period of time (e.g., 1-5 seconds) before stopping)), the computer system configures (710) the physical input mechanism (e.g., 616) to cause the respective device to perform a respective operation (e.g., causing an actuator to move (e.g., causing a door to be opened and/or closed), causing a sound to be adjusted (e.g., increased and/or decreased), causing a temperature to be adjusted) in response to detecting (e.g., by the computer system and/or by the physical input mechanism) an input directed to (e.g., on, at, and/or corresponding to) the physical input mechanism (e.g., 616) (e.g., when the computer system is stopped). In some embodiments, the physical input mechanism was not configured to cause the respective device to perform the operation in response to detecting input on the physical input mechanism before the input directed to the user interface object was detected. Automatically displaying the user interface object when a set of prescribed conditions are met allows the computer system to provide a control that, when selected, configures the physical input mechanism to cause the respective device to perform a respective operation, thereby performing an operation when a set of conditions has been met without requiring further user input and providing the user with additional control options without cluttering the user interface. Displaying the user interface object in accordance with a determination that the computer system will not be moving within the predetermined period of time provides the user with visual feedback regarding the state of the computer system (e.g., the computer system is coming to a stop), thereby providing improved visual feedback.

In some embodiments, while the physical input mechanism (e.g., 616) is configured to cause the respective device to perform the respective operation, the computer system detects a second input (e.g., 605e1 and/or 605f2) (e.g., a touch input, a pressing input, a gaze input, and/or an air input and/or gesture) directed to the physical input mechanism. In some embodiments, in response to detecting the second input directed to the physical input mechanism, the computer system causes the respective device to perform the respective operation (e.g., as described above at FIG. 2F) (and, In some embodiments, transmitting instructions to the respective device (e.g., directly and/or indirectly), where the instructions cause the respective device to perform the respective operation). Causing the respective device to perform the respective operation in response to detecting the second input directed to the physical input mechanism allows the computer system to control an external device via input directed to a hardware component while preserving space on the display of the computer system, thereby providing additional control options without cluttering user interface.

In some embodiments, the physical input mechanism (e.g., 616) is a rotatable input mechanism (e.g., that can be rotated clockwise and/or counterclockwise with respective yaw, pitch, and/or roll). In some embodiments, the rotatable input mechanism is pressable.

In some embodiments, the second input (e.g., 605e1 and/or 605f2) corresponds to (e.g., is pragmatically mapped to, and/or includes) a touch input (e.g., a physical touch and/or that corresponds to a physical touch, a tap input, and/or a pressing input) on the physical input mechanism (e.g., 616) (e.g., and not a rotation of the rotatable input mechanism).

In some embodiments, the respective device is an actuator that adjusts a surface (e.g., a door, a window, a cover, and/or a portion of a housing) (e.g., of the computer system and/or of another computer system and/or device). In some embodiments, causing the respective device to perform the respective operation includes causing the surface via the actuator to move (e.g., up, down, right, and/or left) from a first position to a second position (e.g., as described above at FIG. 2E). Configuring the physical input mechanism to move a surface in response to detecting the first input directed to the user interface object provides a user with more control over the computer system to control the operation of the surface via the physical input mechanism while preserving space on the display of the computer system, thereby providing additional control options without cluttering user interface.

In some embodiments, in accordance with a determination that a first set of one or more criteria is satisfied, the computer system causes the surface via the actuator to move from the first position to the second position includes causing the surface to open (e.g., causing the actuator to move in a first manner, which causes the door to open) (e.g., as described above at FIG. 2F). In some embodiments, causing the surface to open includes causing the surface to move away from a position flush and/or proximate to another surface. In some embodiments, causing the surface to open includes unlocking the surface from the first position. In some embodiments, in accordance with a determination that a second set of one or more criteria is satisfied, causing the surface via the actuator to move from the first position to the second position includes causing the surface to close (e.g., as described above at FIG. 2F) (e.g., causing the actuator to move in a second manner (e.g., different from the first manner), which causes the door to close). In some embodiments, causing the surface to close includes causing the surface to move to a position flush and/or proximate to another surface. In some embodiments, causing the surface to close includes locking the surface into a position after the surface stops moving and/or reaches the second position. Automatically opening or closing the respective device when a set of prescribed conditions are met allows the computer system to selectively actuate the respective device in a respective direction based on the current state (e.g., whether the surface is opened or closed) of the surface (and/or the respective device), which performs an operation when a set of conditions has been met without requiring further user input.

In some embodiments, in accordance with a determination that the user interface object (618 and/or 620) is displayed on a first side of the respective user interface (e.g., user interface at FIGS. 2E and 2F) (e.g., on and/or via a first display component), the respective device is positioned on a first side (e.g., of an external housing and/or structure (e.g., of the computer system and/or a structure) and/or on the computer system) (e.g., as described above at FIG. 2F). In some embodiments, in accordance with a determination that the user interface object is displayed on a second side of the respective user interface (e.g., on and/or via a second display component that is different from the first display component), the respective device is positioned on a second side (e.g., of an external housing and/or structure (e.g., of the computer system and/or a structure) and/or on the computer system) (e.g., as described above at FIG. 2F). Automatically displaying the user interface object on a respective side of the user interface when a set of prescribed conditions are met allows the computer system to perform a display operation that indicates to a user which side that the respective device is located on and/or which respective device that the user interface object will configure the physical input mechanism to control, thereby performing an operation when a set of conditions has been met without requiring user input and providing improved visual feedback.

In some embodiments, while displaying the user interface object (618 and/or 620), the computer system detects that the computer system (e.g., 600) transitions from a first state (e.g., a stopped and/or a non-moving state) to a second state (e.g., a moving state and/or a non-stopped state). In some embodiments, in response to detecting that the computer system transitioned from the first state to the second state, the computer system ceases to display the user interface object (e.g., as described above at FIG. 2B). Ceasing the display of the user interface object in response to detecting that the computer system transitions from a first state to a second state provides the user with visual feedback regarding whether the computer system is moving, thereby providing improved visual feedback.

In some embodiments, while the physical input mechanism (e.g., 616) is configured to cause the respective device to perform the respective operation, the computer system detects that the computer system (e.g., 600) transitions from a third state (e.g., a stopped and/or a non-moving state) to a fourth state (e.g., a moving state and/or a non-stopped state) (e.g., as described above at FIG. 2E). In some embodiments, in response to detecting that the computer system transitions from the third state to the fourth state, the computer system configures the physical input mechanism to not cause the respective device to perform the respective operation in response to detecting input on the physical input mechanism (e.g., as described above at FIG. 2E). Configuring the physical input mechanism to not cause the respective device to perform the operation in response to detecting that the computer system transitions from the third state to the fourth state allows the computer system to control the configuration of the physical input mechanism while preserving space on the display of the computer system, thereby providing additional control options without cluttering user interface.

In some embodiments, while the physical input mechanism (e.g., 616) is configured to cause the respective device to perform the respective operation, the computer system detects that the computer system (e.g., 600) transitions from a fifth state to a sixth state. In some embodiments, in response to detecting that the computer system transitioned from the fifth state to the sixth state, the computer system configures the physical input mechanism to not cause the respective device to perform the respective operation (e.g., as described above at FIG. 2E). In some embodiments, while the physical input mechanism is configured to not cause the respective device to perform the respective operation, the computer system detects a third input (e.g., 605e1, 605e2, 605f1, and/or 605f2) directed to the user interface object (e.g., 618 and/or 620). In some embodiments, in response to detecting the third input (and, In some embodiments, in accordance with a determination that the computer system is moving), the computer system forgoes causing the respective device to perform the respective operation. Not causing the respective device to perform the respective operation in response to detecting the third input while the physical input mechanism is configured to not cause the respective device to perform the respective operation allows the computer system to adjust the control provided to the user in certain situations, thereby performing an operation when a set of conditions has been met without requiring user input.

Note that details of the processes described above with respect to process 700 (e.g., FIG. 3) are also applicable in an analogous manner to other methods described herein. For example, process 800 optionally includes one or more of the characteristics of the various methods described above with reference to process 700. For example, a physical input mechanism can be configured to control the navigation of a computer system using one or more techniques described in relation to process 700 while the computer system is navigating using one or more techniques described in relation to process 800. For brevity, these details are not repeated below.

FIG. 4 is a flow diagram illustrating a method (e.g., process 800) for controlling the navigation of a computer system in accordance with some examples. Some operations in process 800 are, optionally, combined, the orders of some operations are, optionally, changed, and some operations are, optionally, omitted.

As described below, process 800 provides an intuitive way for controlling the navigation of a computer system. Process 800 reduces the cognitive burden on a user for controlling the navigation of a computer system, thereby creating a more efficient human-machine interface. For battery-operated computing devices, enabling a user to control the navigation of a computer system faster and more efficiently conserves power and increases the time between battery charges.

In some embodiments, process 800 is performed at a computer system (e.g., 600) that is in communication with a display component (e.g., 604) (e.g., a display screen and/or a touch-sensitive display), a respective device (e.g., as described above at FIG. 2A) (e.g., a watch, a phone, a tablet, a processor, a head-mounted display (HMD) device, and/or a personal computing device, an actuator for a window and/or a door), and one or more input devices (e.g., 604 and/or 616) (e.g., a physical input mechanism, a camera, a touch-sensitive display, a microphone, and/or a button). In some embodiments, the computer system is a watch, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras). In some embodiments, the computer system is in communication with a physical input mechanism.

While (802) navigating to a first destination (e.g., via a map application) (e.g., as described above at FIG. 2A), the computer system displays (804), via the display component (e.g., 604), a user interface object (e.g., 608) (e.g., a slider).

While (802) navigating to the first destination, while displaying the user interface object (e.g., 608), the computer system detects (806), via one or more input devices (e.g., 604 and/or 616), an input (e.g., 605b) (e.g., a dragging, a sliding, and/or moving input and, In some embodiments, a non-dragging and/or moving input, such as a gaze input that moves, an air gesture that moves, a mouse click-and-drag input, and/or a rotational input) directed to the user interface object (e.g., a input that moves from a first position (e.g., that corresponds to a first position on the user interface object) to a second position (e.g., that corresponds to a second position on the user interface object), where the first position is different from the second position) (e.g., a user interface object that indicates that the computer system will pull over and/or navigate to a position to stop).

In response to (808) detecting the input (e.g., 605b) directed to the user interface object (e.g., 608), the computer system displays (810), via the display component (e.g., 604), a first indication (e.g., 614) (e.g., a waiting indication (e.g., “waiting . . . ” and/or “waiting to stop . . . ”)).

In response to (808) detecting the input directed to the user interface object, the computer system navigates (812) to a second destination (e.g., a place to pullover) instead of the first destination (e.g., as described above at FIG. 2D). In some embodiments, the second destination is determined based on a location of the computer system.

After displaying the first indication (e.g., 614) and in accordance with a determination that a set of one or more criteria is met, wherein the set of one or more criteria includes a criterion that is met when a determination is made that the computer system has reached a second destination (e.g., the computer system has stopped, the computer system is about to stop within a predetermined period of time (e.g., 1-5 seconds)), the computer system ceases (814) displaying the first indication (e.g., as described above at FIG. 2D). Displaying, via the display component, the first indication in response to detecting the input directed to the user interface object provides the user with more control over the user interface while allowing the computer system to provide an indication that informs the user about the safety and/or security of the computer system, thereby providing additional control options without cluttering the user interface and/or improving the safety and security of the computer system.

In some embodiments, after displaying the first indication (e.g., 614) and in accordance with a determination that the set of one or more criteria is met, the computer system configures a respective input mechanism (e.g., 616) (e.g., an input device, a physical input mechanism, a camera, a touch-sensitive display, a microphone, or a button) of the one or more input devices (e.g., 604 and/or 616) to cause the respective device to perform a respective operation (e.g., causing an actuator to move (e.g., causing a door to be opened and/or closed), causing a sound to be adjusted (e.g., increased and/or decreased), and/or causing a temperature to be adjusted) in response to detecting input via the respective input mechanism. In some embodiments, the set of one or more criteria includes a criterion that is met when a determination is made that the computer system is stopped. In some embodiments, after displaying the first indication and in accordance with a determination that the set of one or more criteria is not met, the computer system forgoes configuring the respective input mechanism to cause the respective device to perform the respective operation in response to detecting input via the respective input mechanism. In some embodiments, after displaying the first indication and in accordance with a determination that the set of one or more criteria is not met, the computer system configures the respective input mechanism to not cause the respective device to perform the respective operation in response to detecting input via the respective input mechanism. Configuring the respective input mechanism to cause the respective device to perform the respective operation allows the computer system to selectively configure the respective input mechanism to perform an operation and to provide the user with more control to the computer system, thereby providing additional control options without cluttering user interface and performing an operation when a set of conditions has been met without requiring user input.

In some embodiments, the respective input mechanism (e.g., 616) includes a first physical input mechanism (e.g., 616). In some embodiments, the input (e.g., 605b) is via the first physical input mechanism (e.g., 616). Configuring the first physical input mechanism to cause the respective device to perform a respective operation allows the computer system to selectively configure the first physical input mechanism to perform an operation and to provide the user with more control to the computer system, thereby providing additional control options without cluttering user interface and performing an operation when a set of conditions has been met without requiring user input.

In some embodiments, while the first physical input mechanism (e.g., 616) is configured to cause the respective device to perform the respective operation, in response to detecting input via the respective input mechanism, the computer system detects a first input (e.g., 605e1 and/or 605f1) (e.g., a touch input, a pressing input, a gaze input, and/or an air input and/or gesture) directed to the first physical input mechanism while the computer system (e.g., 600) is stopped. In some embodiments, in response to detecting the first input directed to the first physical input mechanism while the computer system is stopped, the computer system causes the respective device to perform the respective operation (e.g., as described above at FIGS. 2E and 2F). Causing the respective device to perform the respective operation in response to detecting the first input directed to the first physical input mechanism while the computer system is stopped provides the user with additional control over the computer system and increases the safety and security of the computer system, thereby providing additional control options without cluttering user interface and improving the safety and security of the computer system.

In some embodiments, in conjunction with (e.g., immediately after, immediately before, and/or while) causing the respective device to perform the respective operation, the computer system configures the first physical input mechanism (e.g., 616) to cause the computer system (e.g., 600) to perform an operation that is opposite of (e.g., open door versus close door, open window versus close window, turn off vs turn on, and/or window up versus window down) the respective operation in response to detecting input directed to the first physical input mechanism (e.g., as described above at FIG. 2F). In some embodiments, while the first physical input mechanism is configured to cause the respective device to perform the operation that is opposite of the respective operation in response to detecting input on the first physical input mechanism, the computer system detects an input on the first physical input mechanism; and in response to detecting the input on the first physical input mechanism, the computer system performs the operation that is opposite of the respective operation (e.g., without performing the respective operation). Configuring the first physical input mechanism to cause the computer system to perform an operation that is opposite of the respective operation in conjunction with causing the respective device to perform the respective operation allows the computer system to provide the user with an additional control option without displaying additional user interface objects, thereby providing additional control options without cluttering user interface.

In some embodiments, after displaying the first indication (e.g., 614) and in accordance with a determination that a set of one or more criteria is met, the computer system performs a second respective operation (e.g., opening and/or closing a Door As described above at FIG. 2F) (e.g., causing an actuator to move (e.g., causing a door to be opened and/or closed), causing a sound to be adjusted (e.g., increased and/or decreased), causing a temperature to be adjusted) while the computer system (e.g., 600) is stopped (e.g., as described above at FIG. 2E). Performing the second respective operation when a set of conditions are met allows the computer system to automatically perform an operation based on whether the computer system is stopped to improve the safety and security of the security system, thereby performing an operation when a set of conditions has been met without requiring user input and improving the safety and security of the computer system.

In some embodiments, the computer system (e.g., 600) is in communication with a second physical input mechanism (e.g., 616) (and/or in response to detecting the input directed to the user interface object). In some embodiments, while displaying the first indication (e.g., 614), the computer system is not configured to perform a second respective operation (e.g., same as the respective operation) in response to detecting input directed to the second physical input mechanism (e.g., as described above at FIG. 2D). In some embodiments, the second physical input mechanism is the same as the physical input mechanism. Having the computer system not be configured to perform a second respective operation in response to detecting input directed to the second physical input mechanism allows the computer system to improve the safety and security of the security system based on certain conditions, thereby performing an operation when a set of conditions has been met without requiring user input and improving the safety and security of the computer system.

In some embodiments, performing the second respective operation includes opening and/or closing a surface (e.g., as described above at FIGS. 2D-2F) (e.g., a window, a door, a portion of a housing, and/or a component). Opening and/or closing the door when a set of conditions are met allows the computer system to automatically perform an operation based on whether the computer system is stopped to improve the safety and security of the security system, thereby performing an operation when a set of conditions has been met without requiring user input and improving the safety and security of the computer system.

In some embodiments, in response to detecting the input (e.g., 605b) directed to the user interface object (e.g., 608), the computer system initiates a stopping process, wherein the stopping process includes navigating to the second destination instead of the first destination (e.g., as described above at FIG. 2C).

In some embodiments, the stopping process is not initiated while navigating to the first destination and before detecting the input (e.g., 605b) directed to the user interface object (e.g., 608) (e.g., as described above at FIG. 2D).

In some embodiments, navigating to the second destination (e.g., a place to pullover) instead of the first destination includes a determination that the second destination is a destination for stopping (e.g., as described above at FIG. 2D). In some embodiments, in accordance with a determination that the computer system (e.g., 600) can stop at a third destination, the second destination is the third destination. In some embodiments, in accordance with a determination that the computer system cannot stop at the third destination, the second destination is not the third destination.

In some embodiments, in response to detecting the input (e.g., 605b1) directed to the user interface object (e.g., 608), the computer system ceases to display the user interface object (e.g., after predetermined period of time (e.g., 1-10 seconds)) (e.g., as described at FIG. 2D). Ceasing to display the user interface object in response to detecting the input directed to the user interface object allows the computer system to improve the safety and security of the computer system by informing the user concerning the state of the computer system and eliminating a control option from being displayed in certain situations, thereby performing an operation when a set of conditions has been met without requiring user input and improving the safety and security of the computer system.

In some embodiments, after displaying the first indication (e.g., 614) and in accordance with a determination that the computer system (e.g., 600) has not stopped within a first predetermined period of time (e.g., after detecting the input directed to the user interface object), the computer system ceases to display the first indication. In some embodiments, after displaying the first indication and in accordance with a determination that the computer system has stopped within a first predetermined period of time, the computer system displays the first indication. In some embodiments, the computer system does not cease to display the first indication before the first predetermined period of time if the computer system has not stopped. In some embodiments, the computer system ceases to display the first indication before the first predetermined period of time if the computer system has stopped. Ceasing to display the first indication after displaying the first indication and in accordance with a determination that the computer system has not stopped within a first predetermined period of time allows the computer system to improve the safety and security of the computer system by informing the user concerning the state of the computer system and eliminating a control option from being displayed in certain situations, thereby performing an operation when a set of conditions has been met without requiring user input and improving the safety and security of the computer system.

In some embodiments, in response to receiving the request to navigate to the fourth destination, the computer system ceases to display the first indication. Ceasing to display the first indication in response to receiving the request to navigate to the fourth destination allows the computer system to improve the safety and security of the computer system by informing the user concerning the state of the computer system and eliminating a control option from being displayed in certain situations, thereby performing an operation when a set of conditions has been met without requiring user input and improving the safety and security of the computer system.

In some embodiments, in response to receiving the request to navigate to the third destination, the computer system ceases to display the user interface object (e.g., as described above at FIG. 2D). Ceasing to display the user interface object in response to receiving the request to navigate to the third destination allows the computer system to improve the safety and security of the computer system by informing the user concerning the state of the computer system and eliminating a control option from being displayed in certain situations, thereby performing an operation when a set of conditions has been met without requiring user input and improving the safety and security of the computer system.

In some embodiments, while displaying the user interface object (e.g., 608) and in accordance with a determination that a set of one or more criteria is met, the computer system ceases to display the user interface object (e.g., as described above at FIG. 2B). Ceasing to display the user interface object while displaying the user interface object and in accordance with a determination that a set of one or more criteria is met allows the computer system to improve the safety and security of the computer system by informing the user concerning the state of the computer system and eliminating a control option from being displayed in certain situations, thereby performing an operation when a set of conditions has been met without requiring user input and improving the safety and security of the computer system.

Note that details of the processes described above with respect to process 800 (e.g., FIG. 4) are also applicable in an analogous manner to the methods described herein. For example, process 700 optionally includes one or more of the characteristics of the various methods described above with reference to process 800. For example, a physical input mechanism can be configured to control the navigation of a computer system using one or more techniques described in relation to process 700 while the computer system is navigating using one or more techniques described in relation to process 800. For brevity, these details are not repeated below.

This disclosure, for purpose of explanation, has been described with reference to specific embodiments. The discussions above are not intended to be exhaustive or to limit the disclosure and/or the claims to the specific embodiments. Modifications and/or variations are possible in view of the disclosure. Some embodiments were chosen and described in order to explain principles of techniques and their practical applications. Others skilled in the art are thereby enabled to utilize the techniques and various embodiments with modifications and/or variations as are suited to a particular use contemplated.

Although the disclosure and embodiments have been fully described with reference to the accompanying drawings, it is to be noted that various changes and/or modifications will become apparent to those skilled in the art. Such changes and/or modifications are to be understood as being included within the scope of this disclosure and embodiments as defined by the claims.

It is the intent of this disclosure that any personal information of users should be gathered, managed, and handled in a way to minimize risks of unintentional and/or unauthorized access and/or use.

Therefore, although this disclosure broadly covers use of personal information to implement one or more embodiments, this disclosure also contemplates that embodiments can be implemented without the need for accessing such personal information.

What is claimed is:

1. A method, comprising:
at a computer system that is in communication with a display component, a respective device, one or more input devices, and a physical input mechanism:
after displaying a respective user interface:
in accordance with a determination that the computer system will not be moving within a predetermined period of time, displaying, via the display component, a user interface object; and
in accordance with a determination that the computer system will be moving within the predetermined period of time, forgoing displaying the user interface object;
while displaying the user interface object, detecting, via the one or more input devices, a first input directed to the user interface object; and
after detecting the first input directed to the user interface object, configuring the physical input mechanism to cause the respective device to perform a respective operation in response to detecting an input directed to the physical input mechanism.

2. The method of claim 1, further comprising:
while the physical input mechanism is configured to cause the respective device to perform the respective operation, detecting a second input directed to the physical input mechanism; and
in response to detecting the second input directed to the physical input mechanism, causing the respective device to perform the respective operation.

3. The method of claim 2, wherein the physical input mechanism is a rotatable input mechanism.

4. The method of claim 2, wherein the second input corresponds to a touch input on the physical input mechanism.

5. The method of claim 1, wherein the respective device is an actuator that adjusts a surface, and wherein causing the respective device to perform the respective operation includes causing the surface via the actuator to move from a first position to a second position.

6. The method of claim 5, wherein:
in accordance with a determination that a first set of one or more criteria is satisfied, causing the surface via the actuator to move from the first position to the second position includes causing the surface to open; and
in accordance with a determination that a second set one or more of criteria is satisfied, causing the surface via the actuator to move from the first position to the second position includes causing the surface to close.

7. The method of claim 6, wherein:
in accordance with a determination that the user interface object is displayed on a first side of the respective user interface, the respective device is positioned on a first side; and
in accordance with a determination that the user interface object is displayed on a second side of the respective user interface, the respective device is positioned on a second side.

8. The method of claim 1, further comprising:
while displaying the user interface object, detecting that the computer system transitions from a first state to a second state; and
in response to detecting that the computer system transitioned from the first state to the second state, ceasing to display the user interface object.

9. The method of claim 1, further comprising:
while the physical input mechanism is configured to cause the respective device to perform the respective operation, detecting that the computer system transitions from a third state to a fourth state; and
in response to detecting that the computer system transitions from the third state to the fourth state, configuring the physical input mechanism to not cause the respective device to perform the respective operation in response to detecting input on the physical input mechanism.

10. The method of claim 1, further comprising:
while the physical input mechanism is configured to cause the respective device to perform the respective operation, detecting that the computer system transitions from a fifth state to a sixth state;
in response to detecting that the computer system transitioned from the fifth state to the sixth state, configuring the physical input mechanism to not cause the respective device to perform the respective operation;
while the physical input mechanism is configured to not cause the respective device to perform the respective operation, detecting a third input directed to the user interface object; and
in response to detecting the third input, forgoing causing the respective device to perform the respective operation.

11. A non-transitory computer-readable storage medium storing one or more programs configured to be executed by one or more processors of a computer system that is in communication with a display component, a respective device, one or more input devices, and a physical input mechanism, the one or more programs including instructions for:
after displaying a respective user interface:
in accordance with a determination that the computer system will not be moving within a predetermined period of time, displaying, via the display component, a user interface object; and
in accordance with a determination that the computer system will be moving within the predetermined period of time, forgoing displaying the user interface object;
while displaying the user interface object, detecting, via the one or more input devices, a first input directed to the user interface object; and
after detecting the first input directed to the user interface object, configuring the physical input mechanism to cause the respective device to perform a respective operation in response to detecting an input directed to the physical input mechanism.

12. A computer system that is in communication with a display component, a respective device, one or more input devices, and a physical input mechanism, comprising:
one or more processors; and
memory storing one or more programs configured to be executed by the one or more processors, the one or more programs including instructions for:
after displaying a respective user interface:
in accordance with a determination that the computer system will not be moving within a predetermined period of time, displaying, via the display component, a user interface object; and
in accordance with a determination that the computer system will be moving within the predetermined period of time, forgoing displaying the user interface object;
while displaying the user interface object, detecting, via the one or more input devices, a first input directed to the user interface object; and
after detecting the first input directed to the user interface object, configuring the physical input mechanism to cause the respective device to perform a respective operation in response to detecting an input directed to the physical input mechanism.
